(19) United States
(12) Patent Application Publication
(10) Pub. No.: US 2023/0180013 A1
(43) Pub. Date: Jun. 8, 2023

(54) METHOD AND DEVICE FOR ENABLING SPECTRUM SHARING FOR DIFFERENT RADIO ACCESS TECHNOLOGY DEVICES

(71) Applicant: Telefonaktiebolaget LM Ericssson (publ, Stockholm (SE)

(72) Inventors: Zhanxian WANG, Täby (SE); Ying SUN, Täby (SE)

(73) Assignee: Telefonaktiebolaget LM Ericssson (publ), Stockholm (SE)

(21) Appl. No.: 17/923,081

(22) PCT Filed: May 4, 2020
(86) PCT No.: PCT/SE2020/050442

§ 371 Date: Nov. 3, 2022

(51) Int. Cl. H04W 16/14; H04W 72/12

(52) U.S. Cl. CPC H04W 16/14; H04W 72/1215

(57) ABSTRACT

Disclosed is a method performed by a network device (1) for controlling the scheduling of signal transmissions and/or signal receptions for a first communication device (10) operating according to a first Radio Access Technology, first RAT, and a second communication device (20) operating according to a second Radio Access Technology, second RAT, said communication devices (10; 20) sharing a common frequency carrier and operating using an Orthogonal Frequency Division Multiplexing modulation scheme, OFDM modulation scheme. The method comprises the step of coordinating (S1) the scheduling of said first communication device (10) and said second communication device (20) within a common Time Transmission Interval, TTI, such that the first communication device (10) is scheduled on a first subset of the Orthogonal Frequency Division Multiplexing symbols, OFDM symbols, within said TTI and said second communication device (20) is scheduled on a second subset of said OFDM symbols within said TTI. Also disclosed is a related network device (1) and computer program (125).

### TECHNICAL FIELD

The proposed technology generally relates to methods and devices that enables spectrum sharing between different Radio Access Technology devices, RAT devices. More specifically it provides methods and devices for scheduling transmissions and receptions of signals for devices served by different RAT devices.

### BACKGROUND

The gradual introduction of 5G-technology, also referred to as New Radio, NR, to wireless communication networks presents a challenge for service providers to efficiently utilize their time and frequency resources while also enable coexistence between all RATs present in the network. Spectrum sharing provides a way forward where operators are able to support different RATs such as Long Term Evolution, LTE and NR on the same carrier frequencies. Hence in order to introduce 5G gradually even when NR capable device penetration is relatively low, it has been proposed to dynamically share the LTE spectrum with NR. In such a proposal solution, the fundamental mechanism is to resolve the collision between common NR signals and common LTE signals, e.g., L1 control signals, in order to be able to dynamically use the spectrum resources, i.e., both time domain and frequency domain resources. Since this proposal allow NR traffic to transmit and receive in the same time and frequency domain resources as the LTE traffic it may introduce imbalanced traffic behavior from the scheduling point of view. This is in particular true for Ultra Reliable Low Latency Services, URLLC, one of the key NR technology components. URLLC is a time critical remote service and to be able to achieve the round-trip time delay requirement in NR, the NR scheduler is allowed to schedule in shorter time intervals. Any collisions may be avoided by using LTE Mobile Broadband SubFrame Number, LTE MBSFN, special subframes to set up NR common and L1 control signals. The scheduling solution to let NR and LTE traffic negotiate the resources is through the arbitration functionality in communicating with both the NR and LTE scheduler. LTE and NR traffic share resources both in time and frequency domain.

There is however a challenge within the field for scenarios where URLLC services come in as a NR user shares spectrum resources with LTE traffic in non-MBSFN subframes. In particular how one should secure URLLC quality requirements while at the same time increase the spectrum efficiency. To be able to fulfil any time budget requirement laid on URLLC users the networks scheduling functionality has to decide how the time-frequency resources are to be utilized in order to fulfill both the time budget requirements but also to enable that different RATs may exist simultaneously within the network. The latter is of importance since devices belonging to different RATs need to be treated equally by the operator to enable a smooth transit from e.g. the LTE network into the NR network.

The proposed technology aims to provide a mechanism that addresses at least some of the stated challenges.

### SUMMARY

It is an overall object to provide methods and devices that enables a more efficient use of the sparse time and frequency resources available to wireless communication networks providing services to devices using different Radio Access Technologies, RATs

A more specific object is to provide a method that enables a coordinated scheduling of signal transmissions and/or receptions from or to devices using different RATs within the wireless communication network

Another specific object of the proposed technology is to provide a device that enables a coordinated scheduling of transmissions and receptions of signals from and to devices using different RATs within the wireless communication network.

Still another object is to provide a computer program that enables a coordinated scheduling of transmissions and receptions of signals from and to devices using different RATs within the wireless communication network.

These and other objects are met by embodiments of the proposed technology.

According to a first aspect, there is provided a method performed by a network device for controlling the scheduling of signal transmissions and/or signal receptions for a first communication device operating according to a first Radio Access Technology, first RAT, and a second communication device operating according to a second Radio Access Technology, second RAT, the communication devices sharing a common frequency carrier and operating using an Orthogonal Frequency Division Multiplexing modulation scheme, OFDM modulation scheme. The method comprises the step of coordinating the scheduling of the first communication device and the second communication device within a common Time Transmission Interval, TTI, such that the first communication device is scheduled on a first subset of the Orthogonal Frequency Division Multiplexing symbols, OFDM symbols, within the TTI and the second communication device is scheduled on a second subset of the OFDM symbols within the TTI.

According to a second aspect, there is provided a network device configured to control the scheduling of signal transmissions and/or signal receptions for a first communication device operating according to a first Radio Access Technology, first RAT, and a second communication device operating according to a second Radio Access Technology, second RAT, the communication devices sharing a common frequency carrier and operating using an Orthogonal Frequency Division Multiplexing modulation scheme, OFDM modulation scheme. The network device comprises processing circuitry for coordinating the scheduling of the first communication device and the second communication device within a common Time Transmission Interval, TTI, such that the first communication device is scheduled on a first subset of the Orthogonal Frequency Division Multiplexing symbols, OFDM symbols, within the TTI and the second communication device is scheduled on a second subset of the OFDM symbols within the TTI.

According to a third aspect, there is provided a computer program for controlling the scheduling of signal transmissions and/or signal receptions for a first communication device operating according to a first Radio Access Technology, first RAT, and a second communication device operating according to a second Radio Access Technology, second RAT, the communication devices sharing a common frequency carrier and operating using an Orthogonal Frequency Division Multiplexing modulation scheme, OFDM modulation scheme. The computer program comprising instructions, which when executed by at least one processor, cause the at least one processor to coordinate the scheduling of the first communication device and the second communication device within a common Time Transmission Interval, TTI, such that the first communication device is scheduled on a first subset of the Orthogonal Frequency Division Multiplexing symbols, OFDM symbols, within the TTI and the second communication device is scheduled on a second subset of the OFDM symbols within the TTI.

Embodiments of the proposed technology enables a co-scheduling of devices served by different RATs in the same spectrum. This will in turn ensure an efficient use of the available time and frequency resources. This is accomplished by a scheduling mechanism with a low level of complexity that is still able to solve any scheduling collisions between the different devices and displaying equal or higher gain in flexibility.

The proposed solution is particularly well suited to tackle scenarios when there is a plurality of URLLC but it also work for scenarios with few URLLC users in the network. It also provides the ability to handle URLLC traffic in spectrum sharing scenarios when there are different types of RATs involved. Other advantages will be appreciated when reading the detailed description.

### BRIEF DESCRIPTION OF THE DRAWINGS

The embodiments, together with further objects and advantages thereof, may best be understood by making reference to the following description taken together with the accompanying drawings, in which:

FIG. 1 is a schematic illustration of a wireless communication network where a network device communicates with two communication devices served by a radio base station.

FIG. 2 is a schematic flow diagram illustrating a method according to the proposed technology.

FIG. 3 is a schematic flow diagram illustrating an embodiment of the method according to the proposed technology.

FIG. 4 is a block diagram illustrating an embodiment of a network device according to the proposed technology.

FIG. 5 is a block diagram illustrating another embodiment of a network device according to the proposed technology.

FIG. 6 is a schematic illustration of a computer implementation according to the proposed technology.

FIG. 7 is a schematic diagram illustrating an example of how functionality can be distributed or partitioned between different network devices in a general case.

### DETAILED DESCRIPTION

Throughout the drawings, the same reference designations are used for similar or corresponding elements.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

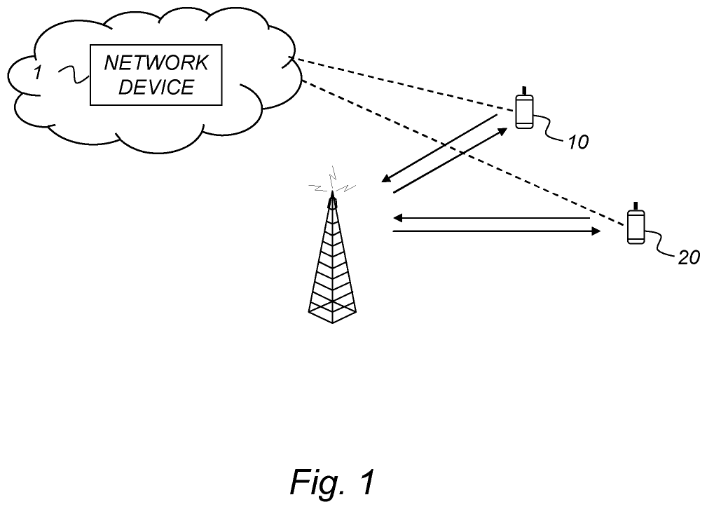

For a better understanding of the proposed technology, it may be useful to begin with a brief system overview and/or analysis of the technical problem. Reference is made to FIG. 1 which illustrates a wireless communication network where a first communication device 10 utilises a first RAT and a second device 20 that utilises a second RAT. The communication devices are in communication with a network device 1 and are served by a radio base station. Let us briefly describe spectrum sharing in a general setting noting that the RATs described may in the form of LTE and NR.

Spectrum sharing relates to scenarios where two devices 10; 20, often belonging to different RATs share available time and frequency resources. Consider for example a time-frequency grid specifying particular times and particular frequencies to be used by a particular device for transmission and/or reception of signals. During scheduling of a device within a Time Transmission Interval the particular frequency grid will normally be filled by the same device and any non-utilized resource within the grid will be wasted. The spectrum sharing mechanism will however enable a different device, possibly belonging to a different RAT as compared to the original device, to use any non-utilized resources for its own communication. Spectrum sharing thus make use of possibly empty slots within the time-frequency grid for scheduling transmissions and/or receptions by additional devices. It is thus possible to create holes in e.g. a NR transmission grid that could instead be used for transmissions in e.g. LTE. That is to say, the different devices may share frequency bands are already available. A very beneficial consequence of this is that devices belonging to a first RAT may utilize the bands of a second RAT without having to actually shut off the second RAT. This will in turn allow for a smooth transition from a first RAT to a second RAT, something that is of great importance to service providers within wireless communication networks.

Consider now the particular case where the first RAT is LTE and the second RAT is NR. LTE typically schedules UEs in TTIs of 1ms, whereas the NR schedules chunks of 2 OFDM symbols, or more, of the 14 symbols present within a TTI. This may result in inefficient use of the TTIs when LTE and NR share a common frequency carrier, as OFDM symbols within a TTI, may be left non-used when just some of its OFM symbols is scheduled to a NR user. The proposed technology aims to overcome this by means of a method that enables a more efficient use of the OFDM symbols within a TTI.

Before we present the proposed technology, we provide a brief explanation of the concept of Orthogonal Frequency Division Multiplexing, OFDM, and OFDM symbols. OFDM is a well-known modulation scheme based on Frequency Division Multiplexing, FDM, where the latter operates so that different streams of information gets mapped to separate and parallel frequency channels. Each of these channels are then separated from the others by a means of a guard band, also referred to as a frequency guard band, in order to alleviate any interference that may occur between adjacent channels. OFDM differs from FDM in some minor details. There is first of all a plurality of carriers that propagate or carry the information stream. These carriers are sometimes referred to as subcarriers and they form an orthogonal set, i.e., all subcarriers are orthogonal to each other. An OFDM signal comprising several subcarriers are modulated in the frequency domain, i.e. each subcarrier are modulated independently, and an inverse Fast Fourier Transform, FFT, is applied to the frequency-domain subcarriers in order to create a time-domain entity referred to as an OFDM symbol. There is moreover inserted, in the time domain, guard intervals between the created OFDM symbols. This is done to prevent any inter-symbol interference at a receiver. A general Time Transmission Interval, TTI, may be seen as a set of concatenated OFDM symbols. Often 14 OFDM symbols together with their guard intervals span a TTI.

The general mechanism behind the proposal resides on the insight that it is possible to schedule the same TTI to both a user 10 of a first RAT and to a user 20 in a second RAT and then ensure that there is not any collisions on the specific OFDM symbols of the TTI. That is, that there is no more than one of the devices that transmit and/or receive on the specific OFDM symbols. The proposal is thus to provide a scheduling of the devices by coordinating the use of the carrier between the different RAT devices.

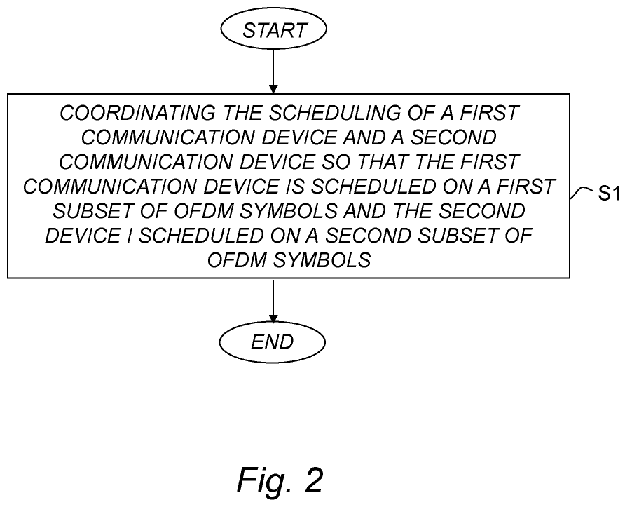

To this end the proposed technology provides a method performed by a network device 1 for controlling the scheduling of signal transmissions and/or signal receptions for a first communication device 10 operating according to a first Radio Access Technology, first RAT, and a second communication device 20 operating according to a second Radio Access Technology, second RAT, the communication devices 10; 20 sharing a common frequency carrier and operating using an Orthogonal Frequency Division Multiplexing modulation scheme, OFDM modulation scheme. The method comprises the step of coordinating S1 the scheduling of the first communication device 10 and the second communication device 20 within a common Time Transmission Interval, TTI, such that the first communication device 10 is scheduled on a first subset of the Orthogonal Frequency Division Multiplexing symbols, OFDM symbols, within the TTI and the second communication device 20 is scheduled on a second subset of the OFDM symbols within the TTI. FIG. 2 is a schematic flow diagram illustrating the proposed method.

In other words, there is provided a method that enables a coordinated scheduling of transmissions and/or receptions of OFDM symbols within a TTI. By coordinating the scheduling so that the first device is scheduled on a first set of OFDM symbols and the second device is scheduled on a second set of OFDM symbols one obtains a more efficient use of the TTI resource. The first set of OFDM symbols may be different from the second set of OFDM symbols to ensure that there are no collisions on the OFDM symbols. Consider for example a scenario where the second RAT is NR and the first RAT is LTE. The device belonging to NR may be scheduled on a subset of the 14 OFDM symbols that make up the TTI. This subset may for example be 4 different OFDM symbols. By allowing the NR device to be scheduled on these OFDM symbols there are still 10 non-utilized OFDM symbols within the TTI. It will now be possible to schedule the LTE device on these particular symbols to avoid wasting valuable resources. By coordinating their scheduling's, it will be possible to allocate particular subsets of OFDM symbols within the TTI to the different devices. To avoid collisions on the OFDM symbols the proposed technology provides a number of different arbitration criterions that can be used to ensure that at most one of the devices transmits/receives on a single OFDM symbol. Such criterions will be described in what follows.

Some of the embodiments contemplated herein will now be described more fully. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

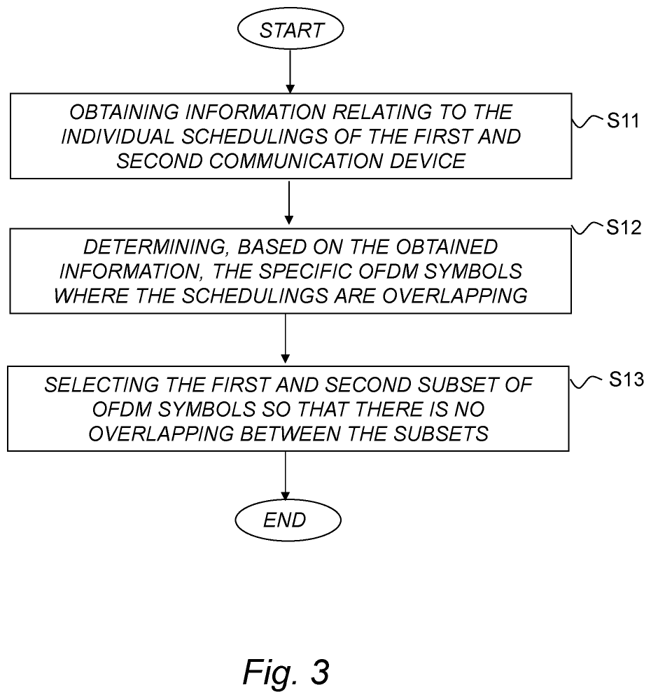

According to a particular embodiment of the proposed technology there is provided a method wherein the step S1 of coordinating the scheduling comprises obtaining S11 information relating to the individual scheduling's of the first and second communication device 10; 20 within the common Time Transmission Interval, TTI. The method also comprises the step of determining S12, based on the obtained information, the specific Orthogonal Frequency Division Multiplexing symbols, OFDM symbols, within the TTI where the scheduling's of the first and second communication device 10; 20 are overlapping. The method also comprises the step of selecting S13 the first and second subset of OFDM symbols such that there is no overlapping between the subsets. FIG. 3 provides a flow diagram illustrating the proposed method.

In other words, there is provided a method where the scheduling's of different devices are coordinated in such a way that there are no transmission or reception collisions among the OFDM symbols. This is ensured by selecting the first and second subsets of OFDM symbols so that there is no overlapping between the subsets. The method is based on obtaining information comprising the individual scheduling's of the different devices. The obtained information is then checked in order to determine if any of the OFDM symbols in the scheduling's are overlapping. If it is shown that some of the OFDM symbols are in fact overlapping the method selects a first and second subset so that the overlapping disappears. How the selection is done may for example be based on determining a prioritized device. That is, if there is present some overlapping among the OFDM symbols one of the devices will be considered the prioritized device. The overlapping part of the OFDM symbols will thus form part of the subset associated with the prioritized device while the subset associated with the non-prioritized device will comprise some other parts of the total set of OFDM symbols. Some examples of how prioritized devices may be selected will be given in what follows.

Another embodiment of the proposed technology provides a method wherein the step S11 of obtaining information comprises obtaining a pre-booking time frequency resource maps from the communication devices 10; 20, and wherein any overlap between the scheduling's of the first and second communication device 10; 20 is based on a comparison between the pre-booking time frequency resource maps.

In this embodiment the information that is obtained and use for checking any overlapping among the OFDM symbols comprises the pre-booked desires or wishes of the different devices. These may be provided as a resource map and be transferred to the network device 1 that performs the scheduling method. The network device may then compare the pre-booking maps obtained from the different devices in order to check whether any OFDM symbols are overlapping. If this is the case the method may proceed and select first and second OFDM symbol subset that are non-overlapping and select the respective device that will be scheduled according to the selected subsets. The selection of the respective device may for example be based on a prioritized device.

To this end, the proposed technology provides an additional embodiment wherein the step S13 of selecting the first and second subset of OFDM symbols comprises to select, for at least some of the OFDM symbols within the TTI, a prioritized communication device from the first and second communication devices 10; 20 to schedule for transmission and/or reception on each OFDM symbol determined to have overlapping scheduling's.

Still another embodiment of the proposed technology provides a method wherein the prioritized communication device is selected based on the latency requirements put on the first and second communication device 10; 20. There is for example often tougher latency requirements put on NR devices compared to LTE, in particular to be able to implement URLLC. A possible default scenario may thus be to always give priority to the NR device. This may however be too crude and in certain scenarios it might be beneficial to give priority to a LTE device, as the following embodiment specifies.

The proposed technology provides a particular embodiment of the proposed method wherein the first RAT comprises a Long Term Evolution Network, LTE network, and the second RAT is a New Radio network, NR network and wherein the first communication device 10 is selected as a prioritized communication device if its scheduling on overlapping OFDM symbols refers to the transmissions of reference signals. Hence, if it is clear that there is an overlapping among the OFDM symbols the LTE device may be given priority if the LTE device aims to transmit reference signals on the overlapping OFDM symbols. These particular OFDM symbols will therefore form part of the subset of OFDM symbols that is associated with the LTE device.

Another example of the proposed technology provides a method wherein the second RAT comprises a New Radio network, NR network and wherein the second communication device 20 is selected as a prioritized communication device if a set maximum waiting time for Ultra Reliable Low Latency communication, URLLC, is exceeded if the second communication device 20 is not selected for transmission and/or reception on the corresponding OFDM symbol. This embodiment will ensure that the NR device will be able to fulfill the URLLC criterions and any overlapping OFDM symbols will be earmarked for the NR device and form part of the OFDM symbol subset that is assigned to the NR device.

Yet another example of the proposed technology provides a method wherein the second RAT comprises a New Radio network, NR network and wherein the first communication device 10 is selected as the prioritized communication device if the second communication device 20 can be scheduled on subsequent OFDM symbols and still fulfill a pre-determined latency requirement associated with the second communication device 20. This embodiment provides a flexible mechanism for selecting OFDM subsets based on prioritized devices. As long as the NR device is given ample time to ensure its latency requirements, i.e., may transmit at a later time and still fulfill the requirements, the LTE device may be selected as the prioritized device.

Still another example of the proposed technology provides a method wherein the first RAT comprises a Long Term Evolution Network, LTE network, and the second RAT comprises a New Radio network, NR network, and wherein the second communication device is selected as a prioritized communication device if the first communication device 10 support mini-slot transmissions.

A particular embodiment of the earlier described method provides a method that further comprises to communicate S2 the outcome to the respective schedulers 11; 21 of the first and second communication device 10; 20.

Having described various embodiments of the proposed technology we will now proceed and describe some examples. These examples are merely intended to further the understanding of the technology and should not be interpreted as narrowing the scope of the same.

We will in the following sections provide some examples of how the proposed technology may be used. We will in particular present scenarios when URLLC services come in as a NR user shares spectrum resources with LTE traffic. One issue in such a scenario is how a NR user that shares spectrum resources with LTE traffic in non-MBSFN subframes secures the NR URLLC QoS requirement with regard to extremely low latency and high reliability while at the same time maximizing spectrum efficiency. The proposed technology provides mechanisms that enable a NR user to fulfil the time budget requirement associated with URLLC connectivity while at the same time enabling a more efficient use of the resources since any resource not used by the NR device may be used by another device utilizing another RAT. This is of utmost importance since the fundamental ideas of having dynamic spectrum sharing is be able to smoothly transit e.g. a LTE network step by step into NR network as the device penetration grows, which means NR coverage and LTE network capacity are of equal importance to the operator.

The proposed technology provides a mechanism for dynamic spectrum sharing scenario that is capable of serving URLLC users without wasting the other resource elements within the same slot. These remaining slots may instead be used for LTE traffic. The mechanism resides on arbitration functionality that is able to negotiate resources between NR and LTE traffic. It is for example possible to schedule 1 resource block which is 12 subcarriers in frequency and 14 OFDM symbols both for URLLC and LTE traffic. Collisions between NR URLLC and LTE reference symbols data symbols can be resolved through a coordination between the different device's individual schedulers. The proposed technology discloses the procedures of the coordination between LTE and NR scheduler with semi-persistent URLLC traffic and dynamic URLLC traffic.

According to one example the maximum waiting time for being scheduled for URLLC users may be calculated based on Quality of Service, QoS, packet delay budget requirements as well as the network configuration. This may be used as input for the arbitration functionality in order to decide which user, the LTE or NR URLLC user that will be prioritized for the shared time and frequency resources in both downlink and uplink.

According to another example the collision between LTE reference symbols and NR URLLC data symbols may be resolved by informing the NR device to avoid reference symbol while muting the symbol positions of the NR device in LTE data symbols. In downlink, muting of LTE data symbol can be done after scheduling decision is made and Layer 1 has been encoded, muting here implies a stop with regard to transmitting overlapping symbols. In Uplink, muting can be done before the scheduling decision is being made, muting here implies to not schedule the user if the user does not support mini-slot. If the LTE user do support mini-slot, muting implies that overlapping time and frequency resources should not be scheduled.

According to another example, the collision between LTE reference symbols and NR URLLC data symbols may be resolved by letting the scheduler predict LTE reference symbols positions for NR URLLC.

The proposed technology provides mechanism that enable an optimization of resource utilizations in both the frequency and the time domain when sharing spectrum between LTE and URLLC traffic. It also provides the capability of serving URLLC users without wasting any LTE resources.

Two different scenarios will now be described, dynamic scheduling of URLLC users and semi-persistent scheduled URLLC users. These two scheduling scenarios are considered for different URLLC traffic.

### Scenario 1: Semi-Persistent Scheduling for NR URLLC

This example discuss how to determine time domain resource allocation for the URLLC user so that the QoS requirement in terms of packet delay budget can be fulfilled. The time domain resource allocation depends on parameters such as TTI length, the maximum waiting time to be scheduled, the number of segmentations, how many retransmissions/repetitions that can be supported.

Below follow concrete examples, the following abbreviations are used:

PDB=Packet Delay Budget

L=TTI length in OFDM symbols

OS=OFDM Symbol

SCS=Subcarrier spacing

To meet PDB<1 ms, with FDD 15 kHz SCS, the scheduler needs to schedule a TTI length of 2 OS and periodicity of every TTI. Segmentation, retransmission/repetitions are not affordable.

To meet PDB<3 ms, there are following scheduling options
L=2 OS, periodicity=1 TTI, can support 1 retransmission with the maximum waiting time of 1 TTI or with single transmission but maximum waiting time of one HARQ RTT.
L=7 OS, periodicity=1 TTI, can support 0 repetition but 3 segmentations or the maximum waiting time of N TTIs with 4−N segmentations.
L=14 OS, periodicity=1 TTI, can support 0 repetition, and 0 segmentation with maximum waiting time of 1 TTI.

Another example adopts different semi-persistent scheduling schemes or dynamic scheduling based on QoS requirement for different URLLC traffic. Typically, in industry scenario, there are three types of URLLC traffic, deterministic periodic traffic, deterministic non-periodic traffic and non-deterministic traffic. For deterministic periodic and deterministic non-periodic traffic, semi-persistent scheduling is used; for non-deterministic, dynamic scheduling is instead used.

According to another example it is possible to determine a resource pre-booking time frequency resource map, which depend on traffic characteristics of a URLLC user. This is done for URLLC user, which is either described as deterministic periodic traffic, or deterministic non periodic traffic. For deterministic periodic traffic, which typically is characterized with extremely low latency, if the PDB requirement does not allow any waiting time, e.g., PDB<=1 ms in low band FDD, the semi-persistent scheduling DCI activation is sent immediately when the flow is setup and the session is created. And the time/frequency resource can be reserved at the time instance where a URLLC packet arrival is expected. For this type of user, the pre-booked resource that is used for URLLC NR user is removed from the available resource map and is not going to to be used by another LTE. The LTE user may instead be scheduled at other time frequency resource but with delay.

For deterministic periodic traffic with relaxed latency, or deterministic non-periodic traffic, the semi-persistent scheduling can be used as well. Both type of traffic has the characteristic that latency requirement is relaxed, and that the potential maximum waiting time is longer than 0. Data Centre Interconnect activation, DCI activation, can be sent immediately when the flow is setup and the session is created. The time frequency pre-booking map may be sent to the arbitration functionality, e.g., the network device performing the proposed technology and it could potentially be reuse by a LTE user if a postponing of the URLLC user is allowed by the QoS requirement. If postponing the URLLC transmission is allowed by maximum waiting time of the URLLC, the arbitrator will suggest a delayed time frequency resource to the NR scheduler and a new DCI is sent to the URLLC UE to postpone the transmission of the URLLC user. The resource used by NR URLLC user will be clean and not be used by a LTE user or any other user. If the URLLC user has be postponed to later time, potentially, retransmission may not be possible with the given packet delay budget requirement, the Hybrid automatic repeat request, HARQ, operating point can be adjusted in link adaptation to support more reliable transmission without or with less retransm issions.

If the maximum waiting time does not allow to postpone the URLLC transmission and it is not possible to avoid collisions with already scheduled LTE transmission, the network device 1 performing the proposed method may send a signal to the LTE scheduler. If the signal is sent at the time that physical layer multiplexing has not been done, the LTE scheduling and physical layer multiplexing will be stopped. The LTE packet can be rescheduled in the next slot. If the signal is sent after physical layer multiplexing, for Downlink, DL, blanking/muting/stopping transmission on radio is possible.

Another example is related to the special case where a NR user initially is using mini-slot type B transmission to avoid LTE DMRS when the maximum waiting time is allowed. Since DMRS in type A slot-based scheduling of LTE users always have a default configuration given by Master Information Block, MIB, message which is before RRC configuration, when the NR scheduler reserves resource for URLLC users it can always assume the presence of LTE transmission and DMRS position. The OFDM symbols selection for NR URLLC user will be selected so that DMRS of LTE symbol position is avoided. It may update this configuration after the arbitration phases after LTE scheduling is performed and whenever it is needed. Such cases are for example when there is no LTE user scheduled, the allocation of NR URLLC traffic can be extended to cover the OFDM symbols initially assumed to be LTE DMRS transmission and potentially type A slot-based scheduling can be used for URLLC. This is especially beneficial when the LTE user is able to support mini-slot based scheduling as well.

Another example is related to the case when the OFDM symbols that are potentially overlapping with LTE DMRS have lower priority than the other symbols potentially for LTE data only transmission. The OFDM symbols that are potentially overlapping with LTE DMRS can be allocated only if the load is high and it requires more symbols to transmit URLLC data. The LTE scheduler may allocate resources and perform link adaptation in consideration of the overlapped/blanked OFDM symbols.

### Scenario 2: Dynamic Scheduling of URLLC Slot

For non-deterministic traffic with typically relaxed latency budget requirement, dynamic scheduling may be used. Both NR URLLC user and LTE user are scheduled with dynamic grant/assignment sent to the device via DCI. The LTE scheduler has a fixed scheduling delay and HARQ processing time, but the NR scheduler might have much shorter scheduling delay and processing time. The LTE scheduler may for example reserve resources 4 ms in advance of the NR dynamic scheduling, the arbitrator, i.e., the network device 1 performing the proposed method may already know that the RB resource has been allocated to an LTE user. If the maximum waiting time of URLLC is allowed it will be possible to postpone the scheduling time of URLLC traffic until it is no longer possible. If the maximum waiting time of the URLLC user does not allow a postponement of the transmission of URLLC traffic, it may be possible to stop scheduling LTE transmission if the network device 1 is able to send this information in a signal before the LTE scheduling decision is sent over the air. This may be achieved by allowing the network device 1 to send signals to the LTE scheduler. If the signal is sent before the scheduling is finalized, the LTE packet can be put back into the RLC buffer and be rescheduled in the next TTI. If the network device 1 can send the signal after the scheduling and L1 multiplexing is finalized but before the scheduling decision is sent to radio unit, the data can be stored in the HARQ buffer and be rescheduled as new transmission in the next TTI. If the network device 1 is able to send a signal after L1 sending scheduled data to the radio unit, the network device can send such a signal directly to the radio unit in order to inform the radio unit that it should mute LTE transmission at the time frequency resource that collides with the resources allocated to the URLLC user.

Another example adopts the scheduling scheme where semi-persistent scheduling scheme is used to schedule initial transmission and dynamic scheduling is used to schedule the consecutive transmissions based on Buffer Status Reports, BSRs, or retransmissions. This example is particularly important for the service with large data rate and critical latency requirement, such as Virtual reality/Augmented Reality, VR/AR. The semi-persistent scheduling is activated with activation DCI based on the priority of the service and using the pre-booked resource. The following dynamic scheduling is using priority dependent scheduling weight that depending on maximum waiting time.

Having described the proposed method and some examples in detail, we will in what follow describe particular devices that can be used when implementing the method. All advantages and benefits associated with, and stated in relation to, the proposed method are equally valid for the device and will not be repeated.

To this end the proposed technology provides a network device 1 configured to control the scheduling of signal transmissions and/or signal receptions for a first communication device 10 operating according to a first Radio Access Technology, first RAT, and a second communication device 20 operating according to a second Radio Access Technology, second RAT, the communication devices 10; 20 sharing a common frequency carrier and operating using an Orthogonal Frequency Division Multiplexing modulation scheme, OFDM modulation scheme. The network device 1 comprises processing circuitry 110 for coordinating the scheduling of the first communication device 10 and the second communication device 20 within a common Time Transmission Interval, TTI, such that the first communication device 10 is scheduled on a first subset of the Orthogonal Frequency Division Multiplexing symbols, OFDM symbols, within the TTI and the second communication device 20 is scheduled on a second subset of the OFDM symbols within the TTI.

As used herein, the non-limiting terms “wireless communication device”, “station”, “User Equipment UE”, and “terminal” or “terminal device” may refer to a mobile phone, a cellular phone, a Personal Digital Assistant PDA, equipped with radio communication capabilities, a smart phone, a laptop or Personal Computer PC, equipped with an internal or external mobile broadband modem, a tablet with radio communication capabilities, a target device, a Machine-to-Machine M2M device, a Machine Type Communication MTC device, an Internet of Thing IoT device, a Device-to-Device D2D UE, a machine type UE or UE capable of machine to machine communication, Customer Premises Equipment CPE, Laptop Embedded Equipment LEE, Laptop Mounted Equipment LME, USB dongle, a portable electronic radio communication device, and/or a sensor device, meter, vehicle, household appliance, medical appliance, camera, television, radio, lightning arrangement and so forth equipped with radio communication capabilities or the like. In particular, the term “wireless communication device” should be interpreted as non-limiting terms comprising any type of wireless device communicating with a network node in a wireless communication system and/or possibly communicating directly with another wireless communication device. In other words, a wireless communication device may be any device equipped with circuitry for wireless communication according to any relevant standard for communication.

As used herein, the term “network device” may refer to any device located in connection with a communication network, including but not limited to devices in access networks, core networks and similar network structures. The term network device may also encompass cloud-based network devices.

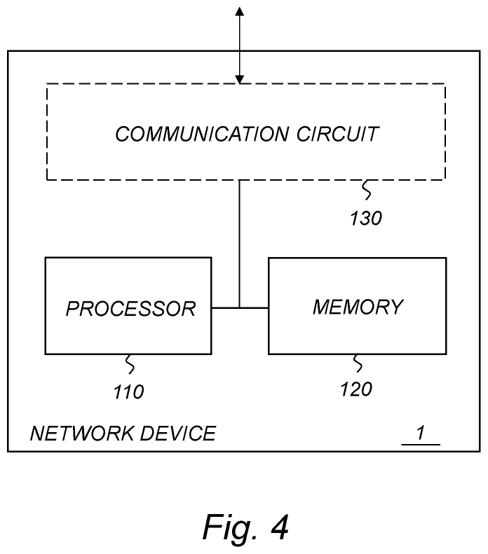

FIG. 4 is a schematic block diagram illustrating an example of a network device 1, based on a processor-memory implementation according to an embodiment. In this particular example, the network device 1 comprises a processor 110 and a memory 120, the memory 120 comprising instructions executable by the processor 110, whereby the processor is operative to coordinate the scheduling of the first communication device 10 and the second communication device 20 within a common Time Transmission Interval, TTI, such that the first communication device 10 is scheduled on a first subset of the Orthogonal Frequency Division Multiplexing symbols, OFDM symbols, within the TTI and the second communication device 20 is scheduled on a second subset of the OFDM symbols within the TTI.

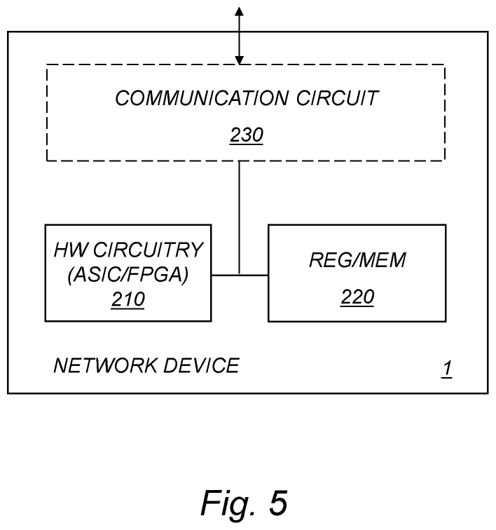

FIG. 5 is a schematic block diagram illustrating another example of a network device 1, based on a hardware circuitry implementation according to an embodiment. Particular examples of suitable hardware circuitry 210 include one or more suitably configured or possibly reconfigurable electronic circuitry, e.g. Application Specific Integrated Circuits ASICs, Field Programmable Gate Arrays FPGAs, or any other hardware logic such as circuits based on discrete logic gates and/or flip-flops interconnected to perform specialized functions in connection with suitable registers REG and/or memory units MEM 220.

The network device 1 may also include a communication circuit 130; 230. The communication circuit 130; 230 may include functions for wired and/or wireless communication with other devices and/or network nodes in the network. In a particular example, the communication circuit 130; 230 may be based on radio circuitry for communication with one or more other nodes, including transmitting and/or receiving information. The communication circuit 130 may be interconnected to the processor 110 and/or memory 120. The communication circuit 230 may be interconnected to the hardware circuitry 210 and/or REG/MEM 220. By way of example, the communication circuit 130; 230 may include any of the following: a receiver, a transmitter, a transceiver, input/output I/O circuitry, input ports and/or output ports.

A particular embodiment of the proposed technology provides a network device 1 that comprises communication circuitry 120 for obtaining information relating to the individual scheduling's of the first and second communication device 10; 20 within the common Time Transmission Interval, TTI. The network device 1 also comprises processing circuitry 110 for determining, based on the obtained information, the specific Orthogonal Frequency Division Multiplexing symbols, OFDM symbols, within the TTI where the scheduling's of the first and second communication device 10; 20 are overlapping, and processing circuitry 110 for selecting the first and second subset of OFDM symbols such that there is no overlapping between the subsets.

Another embodiment of the proposed technology provides a network device 1 that comprises communication circuitry 120 for obtaining a pre-booking time frequency resource maps from the communication devices 10; 20, and processing circuitry 110 for determining any overlap between the scheduling's of the first and second communication device 10; 20 based on a comparison between the pre-booking time frequency resource maps.

Yet another embodiment of the proposed technology provides a network device 1 that comprises processing circuitry 110 for selecting the first and second subset of OFDM symbols by selecting, for at least some of the OFDM symbols within the TTI, a prioritized communication device from the first and second communication devices 10; 20 to schedule for transmission and/or reception on each OFDM symbol determined to have overlapping scheduling's.

Still another embodiment of the proposed technology provides a network device 1 wherein the prioritized communication device is selected based on the latency requirements put on the first and second communication device 10; 20.

By way of example, the proposed technology provides a network device 1 wherein the first RAT comprises a Long Term Evolution Network, LTE network, and the second RAT is a New Radio network, NR network and wherein the first communication device 10 is selected as a prioritized communication device if its scheduling on overlapping OFDM symbols refers to the transmissions of reference signals.

According to another example of the proposed technology there is provided a network device 1 wherein the second RAT comprises a New Radio network, NR network and wherein the second communication device 20 is selected as a prioritized communication device if a set maximum waiting time for Ultra Reliable Low Latency communication, URLLC, is exceeded if the second communication device 20 is not selected for transmission and/or reception on the corresponding OFDM symbol.

According to yet another example of the proposed technology there is provided a network device 1 wherein the second RAT comprises a New Radio network, NR network and wherein the first communication device 10 is selected as the prioritized communication device if the second communication device 20 can be scheduled on subsequent OFDM symbols and still fulfill a pre-determined latency requirement associated with the second communication device 20.

According to still another example of the proposed technology there is provided a network device 1 wherein the first RAT comprises a Long Term Evolution Network, LTE network, and the second RAT comprises a New Radio network, NR network, and wherein the second communication device is selected as a prioritized communication device if the first communication device 10 support mini-slot transmissions.

A particular embodiment of the earlier described device provides a network device 1 wherein the network device comprises communication circuitry 120 for communicating S2 the outcome to the respective schedulers 11; 21 of the first and second communication device 10; 20.

It will be appreciated that the methods and arrangements described herein can be implemented, combined and re-arranged in a variety of ways.

For example, embodiments may be implemented in hardware, or in software for execution by suitable processing circuitry, or a combination thereof.

The steps, functions, procedures, modules and/or blocks described herein may be implemented in hardware using any conventional technology, such as discrete circuit or integrated circuit technology, including both general-purpose electronic circuitry and application-specific circuitry.

Alternatively, or as a complement, at least some of the steps, functions, procedures, modules and/or blocks described herein may be implemented in software such as a computer program for execution by suitable processing circuitry such as one or more processors or processing units.

Examples of processing circuitry includes, but is not limited to, one or more microprocessors, one or more Digital Signal Processors DSPs, one or more Central Processing Units CPUs, video acceleration hardware, and/or any suitable programmable logic circuitry such as one or more Field Programmable Gate Arrays FPGAs, or one or more Programmable Logic Controllers PLCs.

It should also be understood that it may be possible to re-use the general processing capabilities of any conventional device or unit in which the proposed technology is implemented. It may also be possible to re-use existing software, e.g. by reprogramming of the existing software or by adding new software components.

It is also possible to provide a solution based on a combination of hardware and software. The actual hardware-software partitioning can be decided by a system designer based on a number of factors including processing speed, cost of implementation and other requirements.

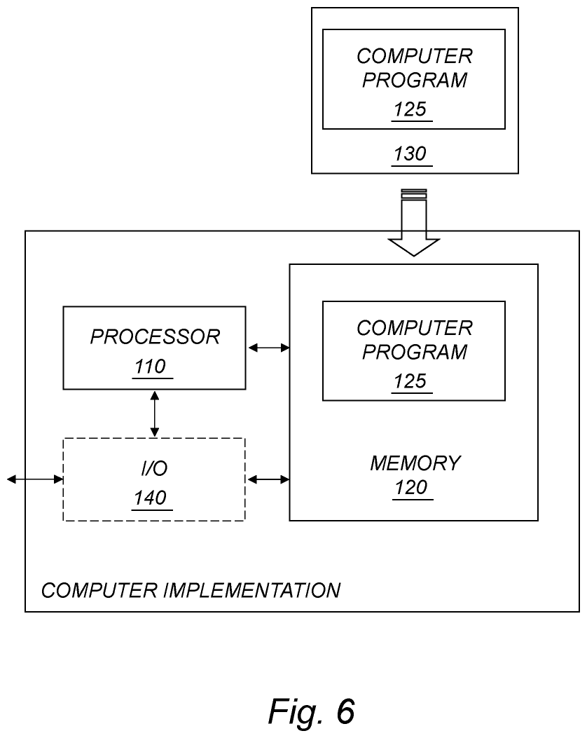

FIG. 6 is a schematic diagram illustrating an example of a computer-implementation according to an embodiment. In this particular example, at least some of the steps, functions, procedures, modules and/or blocks described herein are implemented in a computer program 125; 135, which is loaded into the memory 120 for execution by processing circuitry including one or more processors 110. The processors 110 and memory 120 are interconnected to each other to enable normal software execution. An optional input/output device 140 may also be interconnected to the processors 110 and/or the memory 120 to enable input and/or output of relevant data such as input parameters and/or resulting output parameters.

The term ‘processor’ should be interpreted in a general sense as any system or device capable of executing program code or computer program instructions to perform a particular processing, determining or computing task.

The processing circuitry including one or more processors 110 is thus configured to perform, when executing the computer program 125, well-defined processing tasks such as those described herein.

The processing circuitry does not have to be dedicated to only execute the above-described steps, functions, procedure and/or blocks, but may also execute other tasks.

The proposed technology provides a computer program 125 for controlling the scheduling of signal transmissions and/or signal receptions for a first communication device 10 operating according to a first Radio Access Technology, first RAT, and a second communication device 20 operating according to a second Radio Access Technology, second RAT, the communication devices 10; 20 sharing a common frequency carrier and operating using an Orthogonal Frequency Division Multiplexing modulation scheme, OFDM modulation scheme. The computer program comprising instructions, which when executed by at least one processor, cause the at least one processor to coordinate the scheduling of the first communication device 10 and the second communication device 20 within a common Time Transmission Interval, TTI, such that the first communication device 10 is scheduled on a first subset of the Orthogonal Frequency Division Multiplexing symbols, OFDM symbols, within the TTI and the second communication device 20 is scheduled on a second subset of the OFDM symbols within the TTI.

The proposed technology also provides a computer-program product 130 comprising a computer-readable medium having stored thereon a computer program as above.

The proposed technology also provides a carrier comprising the computer program, wherein the carrier is one of an electronic signal, an optical signal, an electromagnetic signal, a magnetic signal, an electric signal, a radio signal, a microwave signal, or a computer-readable storage medium.

By way of example, the software or computer program 425; 435 may be realized as a computer program product, which is normally carried or stored on a computer-readable medium 420; 430, in particular a non-volatile medium. The computer-readable medium may include one or more removable or non-removable memory devices including, but not limited to a Read-Only Memory ROM, a Random Access Memory RAM, a Compact Disc CD, a Digital Versatile Disc DVD, a Blu-ray disc, a Universal Serial Bus USB memory, a Hard Disk Drive HDD storage device, a flash memory, a magnetic tape, or any other conventional memory device. The computer program may thus be loaded into the operating memory of a computer or equivalent processing device for execution by the processing circuitry thereof.

It is becoming increasingly popular to provide computing services hardware and/or software in network devices such as network nodes and/or servers where the resources are delivered as a service to remote locations over a network. By way of example, this means that functionality, as described herein, can be distributed or re-located to one or more separate physical nodes or servers. The functionality may be re-located or distributed to one or more jointly acting physical and/or virtual machines that can be positioned in separate physical nodes, i.e. in the so-called cloud. This is sometimes also referred to as cloud computing, which is a model for enabling ubiquitous on-demand network access to a pool of configurable computing resources such as networks, servers, storage, applications and general or customized services.

There are different forms of virtualization that can be useful in this context, including one or more of:
Consolidation of network functionality into virtualized software running on customized or generic hardware. This is sometimes referred to as network function virtualization.
Co-location of one or more application stacks, including operating system, running on separate hardware onto a single hardware platform. This is sometimes referred to as system virtualization, or platform virtualization.
Co-location of hardware and/or software resources with the objective of using some advanced domain level scheduling and coordination technique to gain increased system resource utilization. This is sometimes referred to as resource virtualization, or centralized and coordinated resource pooling.

The proposed technology provides a cloud-based network device 1 having functionality of coordinating the scheduling of a first communication device 10 and a second communication device 20 within a common Time Transmission Interval, TTI, such that the first communication device 10 is scheduled on a first subset of the Orthogonal Frequency Division Multiplexing symbols, OFDM symbols, within the TTI and the second communication device 20 is scheduled on a second subset of the OFDM symbols within the TTI. The cloud-based network device 1 may also have the functionality of conveying the outcome or result of the coordination to the schedulers of the communication devices 10; 20. The cloud-based network device 1 may in certain embodiments obtain information about the schedulings of the different devices, coordinating their OFDM symbol scheduling so that no overlapping occurs, and finally convey the end result to the individual scheduling devices associated with the different communication devices.

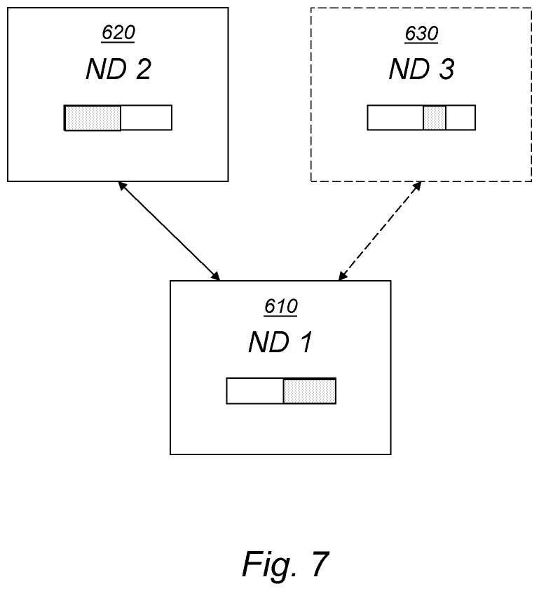

FIG. 7 is a schematic diagram illustrating an example of how functionality can be distributed or partitioned between different network devices in a general case. In this example, there are at least two individual, but interconnected network devices, ND1 and ND2, with reference numerals 610 and 620, respectively, which may have different functionalities, or parts of the same functionality, partitioned between the network devices 610 and 620. There may be additional network devices, such as ND3, with reference numeral 630, being part of such a distributed implementation. The network devices 610-630 may be part of the same wireless communication system, or one or more of the network devices may be so-called cloud-based network devices located outside of the wireless communication system.

FIG. I is a schematic diagram illustrating an example of a wireless communication system, including an access network 710 and/or a core network 720 and/or an Operations and Support System OSS, 730 in cooperation with one or more cloud-based network devices 740. Functionality relevant for the access network 710 and/or the core network 720 and/or the OSS system 730 may be at least partially implemented for execution in a cloud-based network device 740, with suitable transfer of information between the cloud-based network device and the relevant network nodes and/or communication units in the access network and/or the core network and/or the OSS system.

A Network Device ND may generally be seen as an electronic device being communicatively connected to other electronic devices in the network.

By way of example, the network device may be implemented in hardware, software or a combination thereof. For example, the network device may be a special-purpose network device or a general purpose network device, or a hybrid thereof.

A special-purpose network device may use custom processing circuits and a proprietary operating system OS, for execution of software to provide one or more of the features or functions disclosed herein.

A general purpose network device may use common off-the-shelf COTS processors and a standard OS, for execution of software configured to provide one or more of the features or functions disclosed herein.

By way of example, a special-purpose network device may include hardware comprising processing or computing resources, which typically include a set of one or more processors, and physical network interfaces NIs, which sometimes are called physical ports, as well as non-transitory machine readable storage media having stored thereon software. A physical NI may be seen as hardware in a network device through which a network connection is made, e.g. wirelessly through a wireless network interface controller WNIC or through plugging in a cable to a physical port connected to a network interface controller NIC. During operation, the software may be executed by the hardware to instantiate a set of one or more software instances.

According to yet another embodiment, there is provided a hybrid network device, which includes both custom processing circuitry/proprietary OS and COTS processors/standard OS in a network device, e.g. in a card or circuit board within a network device ND. In certain embodiments of such a hybrid network device, a platform Virtual Machine VM, such as a VM that implements functionality of a special-purpose network device, could provide for para-virtualization to the hardware present in the hybrid network device.

1. A method performed by a network device for controlling the scheduling of signal transmissions and/or signal receptions for a first communication device, operating according to a first Radio Access Technology (RAT) and a second communication device operating according to a second (RAT), said communication devices sharing a common frequency carrier and operating using an Orthogonal Frequency Division Multiplexing (OFDM) modulation scheme, the method comprising:
coordinating the scheduling of said first communication device and said second communication device within a common Time Transmission Interval (TTI) such that the first communication device is scheduled on a first subset of the OFDM symbols within said TTI and said second communication device is scheduled on a second subset of said OFDM symbols within said TTI.

2. The method of claim 1, wherein the step of coordinating the scheduling comprises:
obtaining information relating to the individual scheduling's of said first and second communication device within said common (TTI);
determining, based on said obtained information, the specific OFDM symbols within said TTI where the scheduling's of said first and second communication device are overlapping; and
selecting said first and second subset of OFDM symbols such that there is no overlapping between said subsets.

3. The method of claim 2, wherein
the step of obtaining information comprises obtaining a pre-booking time frequency resource maps from said communication devices, and
any overlap between the scheduling's of said first and second communication device is based on a comparison between said pre-booking time frequency resource maps.

4. The method of claim 1, wherein the step of selecting said first and second subset of OFDM symbols comprises to select, for at least some of the OFDM symbols within said TTI, a prioritized communication device from said first and second communication devices to schedule for transmission and/or reception on each OFDM symbol determined to have overlapping scheduling's.

5. The method of claim 4, wherein the prioritized communication device is selected based on the latency requirements put on said first and second communication device.

6. The method of claim 4, wherein said first RAT comprises a Long Term Evolution (LTE) network, and said second RAT is a New Radio (NR) network and wherein said first communication device is selected as a prioritized communication device if its scheduling on overlapping OFDM symbols refers to the transmissions of reference signals.

7. The method of claim 4, wherein
said second RAT comprises a New Radio (NR) network and said second communication device is selected as a prioritized communication device if a set maximum waiting time for Ultra Reliable Low Latency communication (URLLC) is exceeded if said second communication device is not selected for transmission and/or reception on the corresponding OFDM symbol.

8. The method of claim 4, wherein
said second RAT comprises a New Radio (NR) network and said first communication device is selected as the prioritized communication device if said second communication device can be scheduled on subsequent OFDM symbols and still fulfill a pre-determined latency requirement associated with said second communication device.

9. (canceled)

10. The method of claim 1, wherein the method further comprises to communicate the outcome to the respective schedulers of said first and second communication device.

11. A network device configured to control the scheduling of signal transmissions and/or signal receptions for a first communication device operating according to a first Radio Access Technology (RAT) and a second communication device operating according to a second RAT, said communication devices sharing a common frequency carrier and operating using an Orthogonal Frequency Division Multiplexing (OFDM) modulation scheme, the network device comprising:
processing circuitry for coordinating the scheduling of said first communication device and said second communication device within a common Time Transmission Interval (TTI) such that the first communication device is scheduled on a first subset of the OFDM symbols within said TTI and said second communication device is scheduled on a second subset of said OFDM symbols within said TTI.

12. The network device of claim 11, wherein the network device comprises:
communication circuitry for obtaining information relating to the individual scheduling's of said first and second communication device within said common (TTI);
processing circuitry for determining, based on said obtained information, the specific OFDM symbols within said TTI where the scheduling's of said first and second communication device are overlapping; and
processing circuitry for selecting said first and second subset of OFDM symbols such that there is no overlapping between said subsets.

13. The network device of claim 12, wherein the network device comprises communication circuitry for obtaining a pre-booking time frequency resource maps from said communication devices, and processing circuitry for determining any overlap between the scheduling's of said first and second communication device based on a comparison between said pre-booking time frequency resource maps.

14. The network device of claim 11, wherein the network device comprises processing circuitry for selecting said first and second subset of OFDM symbols by selecting, for at least some of the OFDM symbols within said TTI, a prioritized communication device from said first and second communication devices to schedule for transmission and/or reception on each OFDM symbol determined to have overlapping scheduling's.

15. The network device of claim 14, wherein the prioritized communication device is selected based on the latency requirements put on said first and second communication device.

16. The network device of claim 14, wherein said first RAT comprises a Long Term Evolution (LTE) network and said second RAT is a New Radio (NR) network and wherein said first communication device is selected as a prioritized communication device if its scheduling on overlapping OFDM symbols refers to the transmissions of reference signals.

17. The network device of claim 14, wherein said second RAT comprises a New Radio (NR) network and wherein said second communication device is selected as a prioritized communication device if a set maximum waiting time for Ultra Reliable Low Latency communication (URLLC) is exceeded if said second communication device is not selected for transmission and/or reception on the corresponding OFDM symbol.

18. The network device of claim 14, wherein said second RAT comprises a New Radio (NR) network and wherein said first communication device is selected as the prioritized communication device if said second communication device can be scheduled on subsequent OFDM symbols and still fulfill a pre-determined latency requirement associated with said second communication device.

19. The network device of claim 14, wherein said first RAT comprises a Long Term Evolution (LTE) network and said second RAT comprises a New Radio (NR) network, and wherein said second communication device is selected as a prioritized communication device if said first communication device support mini-slot transmissions.

20. The network device of claim 11, wherein the network device comprises communication circuitry for communicating the outcome to the respective schedulers of said first and second communication device.

21. A non-transitory computer readable storage medium storing a computer program for controlling the scheduling of signal transmissions and/or signal receptions for a first communication device operating according to a first Radio Access Technology, first RAT, and a second communication device operating according to a second Radio Access Technology, second RAT, said communication devices sharing a common frequency carrier and operating using an Orthogonal Frequency Division Multiplexing modulation scheme, OFDM modulation scheme, said computer program comprising instructions, which when executed by at least one processor, cause the at least one processor to:
coordinate the scheduling of said first communication device and said second communication device within a common Time Transmission Interval, TTI, such that the first communication device is scheduled on a first subset of the Orthogonal Frequency Division Multiplexing symbols, OFDM symbols, within said TTI and said second communication device is scheduled on a second subset of said OFDM symbols within said TTI.

22. (canceled)
